(19) United States
(12) Patent Application Publication
(10) Pub. No.: US 2006/0046118 A1
(43) Pub. Date: Mar. 2, 2006

(54) Fuel cell stack having improved cooling structure

(76) Inventors: Dong-Myung Suh, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/210,472

(22) Filed: Aug. 23, 2005

(30) Foreign Application Priority Data
Aug. 30, 2004 (KR) 10-2004-0068739

(51) Int. Cl. H01M 8/04; H01M 8/10; H01M 8/24

(52) U.S. Cl. 429/26; 429/38; 429/32

(57) ABSTRACT

A cooling system for a fuel cell stack is provided. The fuel cell stack includes electricity generators generating electric energy through an electrochemical reaction between hydrogen and oxygen, and separators between the electricity generators. It may also contain cooling plates between the electricity generators. Cooling channels including main channels and branch channels coupling the main channels together are formed in the separators or the cooling plates. The intersection of the main and branch cooling channels forms grid-shaped areas with pillars in between that are rectangular, triangular, circular, shaped like a parallelogram, or formed in a combination of these shapes. The cooling channels increase the contact area between the coolant and the separators or the cooling plates and therefore the cooling efficiency of a stack.

### CROSS REFERENCE TO RELATED APPLICATION

This application claims priority to and the benefit of Korean patent application No. 10-2004-0068739 filed in the Korean Intellectual Property Office on Aug. 30, 2004, the entire content of which is incorporated herein by reference.

### FIELD OF THE INVENTION

The present invention relates to a fuel cell system and more particularly to a stack having an improved cooling structure and a fuel cell system including the stack.

### BACKGROUND OF THE INVENTION

A fuel cell is an electricity generating system directly converting chemical reaction energy into electric energy through an electrochemical reaction between hydrogen and oxygen. The hydrogen is usually contained in a hydrocarbon material such as methanol, ethanol, or natural gas and the oxygen may come from air or from an oxygen tank.

The fuel cell can generate electric energy through an electrochemical reaction between a fuel and an oxidant without combustion while also generating heat as a byproduct.

Recently developed polymer electrolyte membrane fuel cells (PEMFC) have excellent output characteristics, low operation temperatures, and fast start and response characteristics. The PEMFC includes a stack, which is the main body of the fuel cell, a fuel tank, and a fuel pump supplying the fuel from the fuel tank to the stack. The PEMFC may further include a reformer reforming the fuel to generate hydrogen and for supplying the hydrogen to the stack.

In the PEMFC, the fuel stored in the fuel tank is supplied to the reformer by a fuel pump. The reformer reforms the fuel and generates hydrogen. The stack generates electric energy through an electrochemical reaction between the hydrogen and oxygen.

In the fuel cell system, the stack generating electric energy is constructed with several to tens of unit cells each having a membrane-electrode assembly (MEA) and separators. Separators are also referred to as bipolar plates in the art. The unit cells are electricity generators of the stack.

The MEA has an anode and a cathode attached to surfaces of an electrolyte membrane. The separator serves as a passage through which hydrogen and oxygen needed for the electrochemical reactions are supplied to the anode and the cathode of the MEA. In addition, the separator serves as a conductor serially coupling the anodes and cathodes of adjacent MEAs.

Through the separator, the hydrogen-containing fuel is supplied to the anode, and oxygen or oxygen-containing air is supplied to the cathode. Electrochemical oxidation of fuel gas occurs at the anode, and electrochemical reduction of oxygen occurs at the cathode, giving rise to a current of electrons. Electricity, heat, and water are generated from the electron current.

The stack in the fuel cell system must be maintained at a proper operating temperature in order to secure stability of the electrolyte membrane and to prevent deterioration in performance of the electrolyte membrane. For this, the stack has cooling channels. A low temperature coolant such as water or air flowing through the cooling channels can cool the heated stack.

In conventional fuel cell systems, contact area between the coolant or the cooling channel and the MEA is limited. Therefore, transfer of heat from the MEA to the coolant is limited and the cooling efficiency of the stack is low.

### SUMMARY OF THE INVENTION

A fuel cell stack is provided that improves cooling efficiency by an enhanced structure of cooling channels.

According to one aspect of the present invention, a fuel cell stack including at least one electricity generator generating electric energy through an electrochemical reaction between hydrogen and oxygen, and cooling channels containing a coolant to cool the electricity generator are provided, wherein the cooling channels include a plurality of main channels and at least one branch channel branching from at least one of the main channels to couple the main channels together.

In one embodiment, the main channels may be parallel to one another, and the branch channel may be perpendicular to the main channels.

In another embodiment, the electricity generator may include a MEA, and separators located on both sides of the MEA, and the cooling channel may be formed in the separators.

Protrusions defined by the main and branch channels may have a rectangular or triangular shape or may be in the shape of a parallelogram such as a lozenge, or a combination of these shapes.

In other embodiments, the stack may include a plurality of the electricity generators, where the cooling channels are formed by combining the opposite separators. The MEA may be attached on one side of the combined opposite separators where the cooling channels are formed. The stack may include a plurality of the electricity generators, where the cooling channels are formed in cooling plates located between the electricity generators.

Pillars defined by the main and branch channels may have the shape of a rectangle, a parallelogram, a triangle, or a combination of these shapes.

In one other embodiment, a stack being used in a fuel cell system is presented that includes membrane-electrode assemblies, separators placed between adjacent membrane-electrode assemblies in pairs of opposing separators, main channels formed along a first direction between the pairs of opposing separators, branch channels formed between the pairs of opposing separators along a second direction intersecting the first direction and connecting the main channels together, inlets formed in each pair of opposing separators and connected to the main channel formed between the pair of opposing separators, and outlets formed in each pair of opposing separators and connected to the main channel formed between the pair of opposing separators, where the main channels and the branch channels of each pair of opposing separators are adapted to receive a cooling fluid injected through the inlet and flowing out of the outlet. The intersection of the main channels and the branch channels forms a grid of channels with solid protrusions in between, and the pillars are shaped in a form selected from the group consisting of rectangular form, triangular form, parallelogram form, circular form, or a combination thereof.

One embodiment presents a stack being used in a fuel cell system, the stack including unit cells, each unit cell having a membrane-electrode assembly located between two separators contacting the membrane-electrode assembly on both sides, cooling plates placed between adjacent unit cells, main channels formed along a first direction in the cooling plates, branch channels formed in the cooling plates along a second direction intersecting the first direction and connecting the main channels together, inlets formed in one cooling plate and connected to the main channel formed in the cooling plate, and outlets formed in each cooling plate and connected to the main channel formed in the cooling plate, where the main channels and the branch channels of each cooling plate are adapted to receive a cooling fluid injected through the inlet and flowing out of the outlet. Intersection of the main channels and the branch channels forms a grid of channels with solid pillars in between, and the pillars are shaped in a form selected from the group consisting of rectangular form, triangular form, parallelogram form, circular form, or a combination thereof.

In various embodiments of the present invention, grid-shaped cooling channels are formed in the separators or in the cooling plates in a fuel cell stack, to increase the contact area between the coolant and the separators or the cooling plates. These cooling channels improve the thermal transfer efficiency of the coolant and the cooling efficiency of the stack.

### BRIEF DESCRIPTION OF THE DRAWINGS

FIG. 1 is a block diagram of a fuel cell system according to an embodiment of the present invention.

FIG. 2 is an exploded perspective view of a stack according to a first embodiment of the present invention.

FIG. 3 is a first modified example of the first embodiment of the present invention.

FIG. 4 is a second modified example of the first embodiment of the present invention.

FIG. 5 is an exploded perspective view of a stack according to a second embodiment of the present invention.

FIG. 6 is a plan view of a cooling plate according to the second embodiment of the present invention.

FIG. 7 is a first modified example of the second embodiment of the present invention.

FIG. 8 is a second modified example of the second embodiment of the present invention.

### DETAILED DESCRIPTION

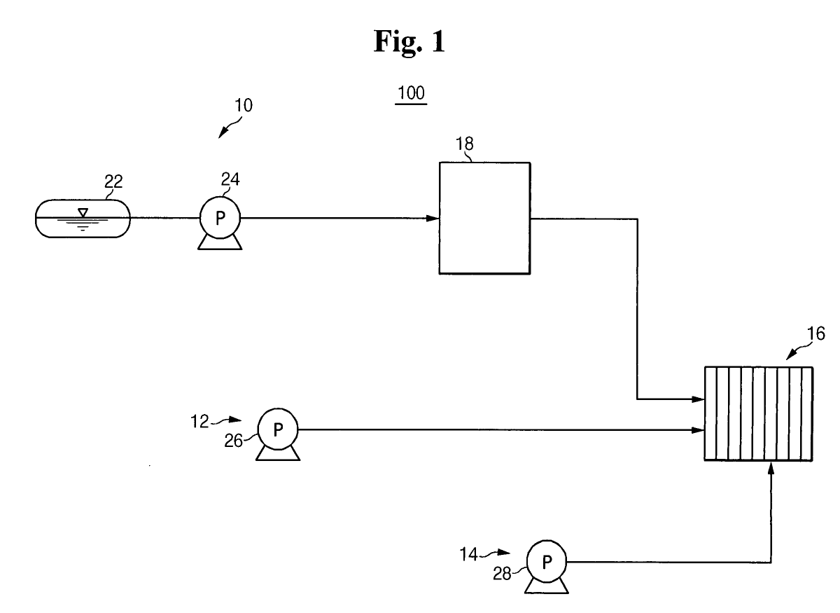

FIG. 1 is a block diagram illustrating a fuel cell system 100 according to an embodiment of the present invention. The fuel cell system 100 may employ a PEMFC, generating hydrogen and generating electric energy through an electrochemical reaction between the hydrogen generated and oxygen.

The fuel used for the fuel cell system 100 may include a liquid or gas hydrogen-containing fuel such as methanol, ethanol, or natural gas. For convenience of description, the fuel used in the description below is a liquid fuel. As the oxidant used for reacting with hydrogen, the fuel cell system 100 may utilize pure oxygen stored in an additional storage device or oxygen-containing air. In the following description, air is used as the oxidant.

The fuel cell system 100 of FIG. 1 includes a reformer 18 for reforming hydrogen-containing fuel to generate hydrogen, a stack 16 generating electric energy through an electrochemical reaction of the hydrogen and oxygen, a fuel supply unit 10 supplying the fuel to the reformer 18, and an air supply unit 12 supplying air to the stack 16.

The fuel cell system 100 of the present invention may also employ a direct oxidation fuel cell scheme to generate electric energy by directly supplying a hydrogen-containing liquid fuel to the stack 16. Unlike the PEMFC, the direct oxidation fuel cell does not include the reformer 18. While the present invention may include both a direct oxidation scheme and a PEMFC scheme, the fuel cell system 100 described below uses a PEMFC scheme.

The stack 16 is coupled to the reformer 18 and to the oxygen supply unit 12. The stack 16 receives a reformed gas from the reformer 18 and air from the oxygen supply unit 12, and generates electric energy through an electrochemical reaction between the hydrogen and oxygen contained in the air.

The fuel supply unit 10 includes a fuel tank 22 for storing the fuel, and a fuel pump 24 coupled to the fuel tank 22 to discharge the fuel stored in the fuel tank to the reformer 18. The oxygen supply unit 12 includes an air pump 26 for drawing air and supplying the air to the stack 16.

The reformer 18 generates a reformed gas from the fuel through a chemical catalytic reaction using thermal energy and reduces a concentration of carbon monoxide contained in the reformed gas. The catalytic reaction used by the reformer 18 to generate the reformed gas from the fuel may be a steam reforming reaction, a partial oxidation reaction, or an auto-thermal reaction. The reformer 18 reduces the concentration of carbon monoxide contained in the reformed gas through a water-gas shift (WGS) reaction, a preferential oxidation (PROX) reaction, or a purification reaction of hydrogen with a separating membrane.

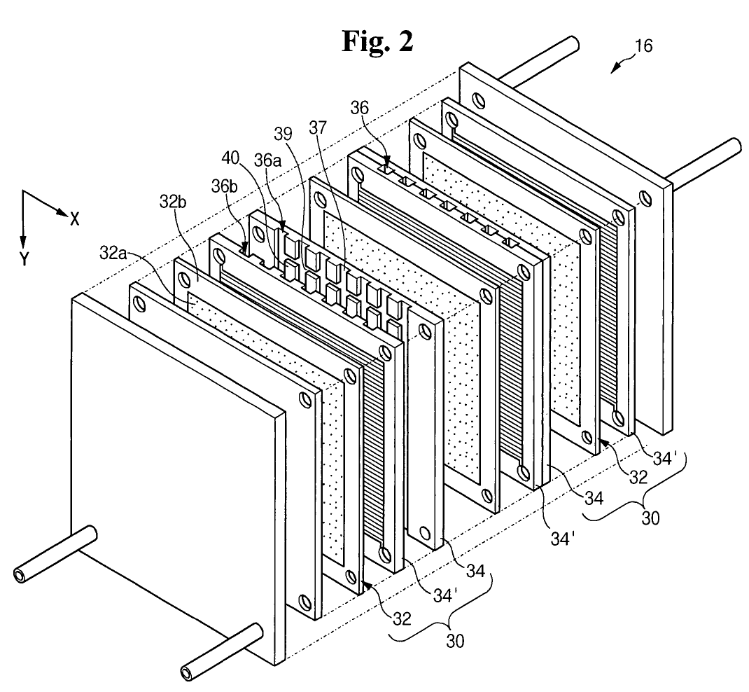

FIG. 2 is an exploded perspective view of a stack 16 according to a first embodiment of the present invention. The stack 16 in the fuel cell system 10 includes electricity generators 30 as a minimum unit for generating electric energy. In each electricity generator 30, separators 34, 34′ are located in close contact with both surfaces of a MEA 32. The stack 16 is constructed by sequentially stacking a plurality of the electricity generators 30.

An anode is located on one side of the MEA 32, and a cathode is located on the other side of the MEA 32. The MEA 32 has an electrolyte membrane between the anode and the cathode.

The anode receives the reformed gas through the separator 34. The anode is constructed with a catalyst layer for decomposing the reformed gas into electrons and hydrogen ions and a gas diffusion layer for promoting movement of the electrons and the reformed gas.

The cathode receives the air through the separator 34′. The cathode is constructed with a catalyst layer for causing a reaction between the electrons, the hydrogen ions, and oxygen contained in the air to generate water. The cathode also includes a gas diffusion layer for promoting movement of the oxygen.

The electrolyte membrane is made from a solid polymer electrolyte having a thickness of 50 μm to 200 μm. The electrolyte membrane has an ion exchange function for moving the hydrogen ions generated by the catalyst layer of the anode to the catalyst layer of the cathode.

The separators 34, 34′ located close to both sides of the MEA 32 supply the reformed gas and the air to the MEA 32, the anode, and the cathode. In addition, the separators 34, 34′ serve as conductors serially coupling the anodes and cathodes of the MEAs 32 in the stack 16.

During the operation of the fuel cell system 100, the reduction reaction occurring in the electricity generators 30 generates thermal energy. Because thermal energy dries the MEA 32, it deteriorates performance of the stack 16. Therefore, the fuel cell system 100 of the present invention includes a cooling structure that circulates a coolant within the stack 16 to cool the heated electricity generators 30.

The fuel cell system 100 includes a coolant supply unit 14 (FIG. 1) supplying the coolant to an interior of the stack 16. The stack 16 includes cooling channels 36 in the electricity generators 30, allowing the coolant supplied from the coolant supply unit 14 to flow though the electricity generators 30.

The coolant supply unit 14 includes a coolant pump 28 drawing and supplying the coolant to the stack 16. The coolant pump 28 is coupled to the cooling channels 36 in the stack 16 to supply the coolant to the electricity generators 30. In the present invention, the coolant may be a cooling water or a cooling gas. However, because air is easy to obtain and because air temperature is usually lower than an internal temperature of the stack 16 in operation, the following description assumes air as the coolant.

In the embodiment shown, the coolant supply unit 14 having the coolant pump 28 is used to supply the coolant to the stack 16. Alternatively, cooling air may be supplied to the cooling channels 36 through natural convection and without any coolant supply units 14.

Each of the cooling channels 36 is a path for the coolant, supplied from the coolant supply unit 14, to flow to the electricity generator 30 in order to cool the heated electricity generator 30. The cooling channels 36 may have various shapes and may be located at various locations in the stack 16. In the stack 16 shown in FIG. 2, the cooling channels 36 are formed in the separators 34, 34′.

The cooling channels 36 are formed by combining one channel 36a located on a surface of the separator 34 and another channel 36b located on a surface of the opposite separator 34′. The MEA 32 is attached on one side of the combined separators 34, 34′ where the cooling channels 36 are formed, so that the entire surface of the MEA 32 including active regions 32a and inactive regions 32b can be cooled.

According to the first embodiment, the cooling channels 36 include a plurality of main channels 37 and at least one branch channel 39. As shown in FIG. 2, the main channels 37 extend along a vertical direction of the separators 34, 34′ (Y direction in the figure). The branch channels 39 branch from at least one of the main channels 37 and couple the main channels 37 together.

The main channels 37 are located parallel to one another and may extend along the vertical direction of the separators 34. The separation between the main channels 37 may be varied. The coolant supplied from the coolant supply unit 14 is injected into the one end of the main channels 37 and discharged from the other end of the main channels 37.

The branch channels 39 extend along a direction perpendicular to the main channels 37. Both ends of each branch channel 39 are coupled to the main channels 37. As a result, the cooling channels 36 of the first embodiment are grid shaped with the grids formed by intersecting main and branch channels 37, 39. In addition, protrusions 40 defined by the main and branch channels 37, 39 have a rectangular shape.

Although in the embodiment shown in FIG. 2, the main channels 37 extend parallel to one another along the vertical (Y) direction and the branch channels 39 extend parallel to one another along the horizontal (X) direction, the cooling channels 36 of the present invention are not so limited. Alternatively, the main channels 37 may extend along the horizontal (X) and the branch channels 39 may extend along the vertical (Y) direction. In the first embodiment, the main channels 37 and the branch channels 39 need only be perpendicular to one another in order to form a grid. Moreover, in a rectangular stack, the main and branch channels 37, 39 extend along the sides of the rectangular MEAs 32. Otherwise, the paths of the main and branch channels 37, 39 are interchangeable.

During operation of the stack 16, the thermal energy generated as a byproduct of the electrochemical reactions in the electricity generators 30 is transferred to the separators 34, 34′ heating the separators 34, 34′. The coolant supplied from the coolant supply unit 14 flows through the cooling channels 36, so that the heated separators 34, 34′ are cooled by the coolant. The coolant disperses from the main channels 37 into the branch channels 39 within the grid-shaped cooling channels 36. As a result, contact area between the coolant and the separators 34, 34′ is increased, and thermal exchange rate between the separators 34, 34′ and the coolant is improved.

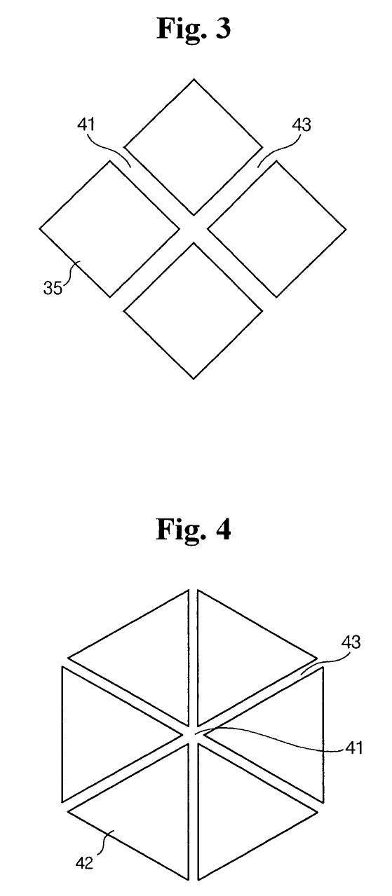

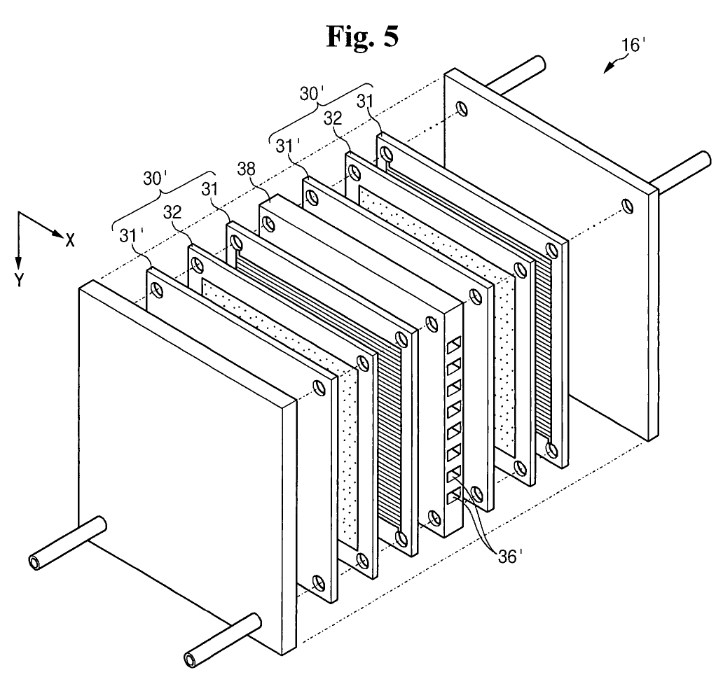

FIGS. 3 and 4 show first and second modified examples of the first embodiment of the present invention. In the first modified example shown in FIG. 3, protrusions 35 defined by the main and branch channels 41, 43 have a parallelogram shape. In the second modified example shown in FIG. 4, protrusions 42 defined by the main and branch channels 41, 43 have a triangular shape.

In the first and second modified examples of the first embodiment, the cooling channels 36 are formed with the main and branch channels 41, 43, but the protrusions 35, 42 defined by the main and branch channels are not limited to the shapes shown. The protrusions may have various shapes.

FIG. 5 is an exploded perspective view of a stack 16′ according to a second embodiment of the present invention. The stack 16′ according to the second embodiment includes additional cooling plates 38 located between adjacent electricity generators 30′. Cooling channels 36′ are formed in the cooling plates 38. The cooling plates 38 located between the separators 31, 31′ of the adjacent electricity generators 30′ function as a heat release plate for releasing the thermal energy transferred from the separators 31, 31′ during the operation of the electricity generators 30′. The cooling plates 38 further improve the cooling efficiency for cooling the MEA 32. The cooling plates 38 may be made from a thermally-conductive material such as aluminum, cooper, or iron.

The cooling channels 36′ are constructed with a plurality of channels located within the cooling plates 38. The cooling channels 36′ may extend along one of the sides of the cooling plates 38 (X direction of the figure).

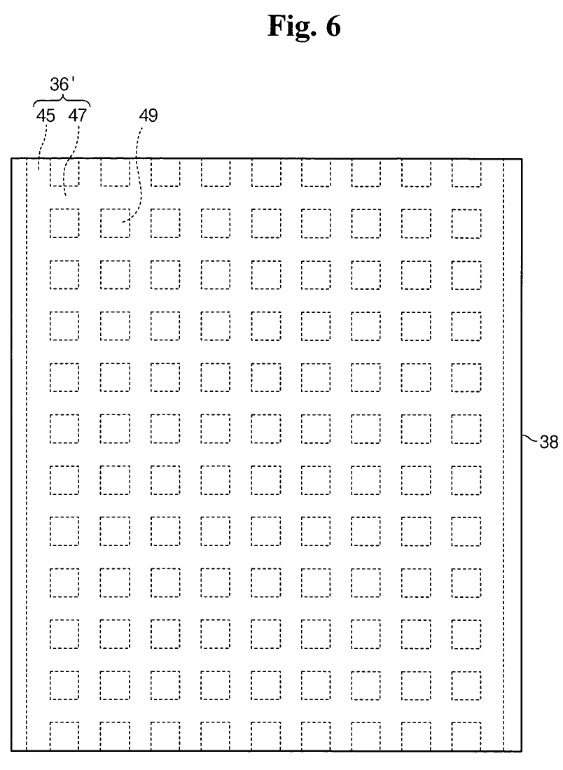

FIG. 6 is a plan view of a cooling plate 38 according to the second embodiment of the present invention. The cooling channels 36′ of the second embodiment are also formed with a combination of the main and branch channels 45, 47 located within the cooling plates 38. Because the construction and operation of the cooling channels 36′ are similar to the cooling channels 36 of the first embodiment, detailed description of them is omitted.

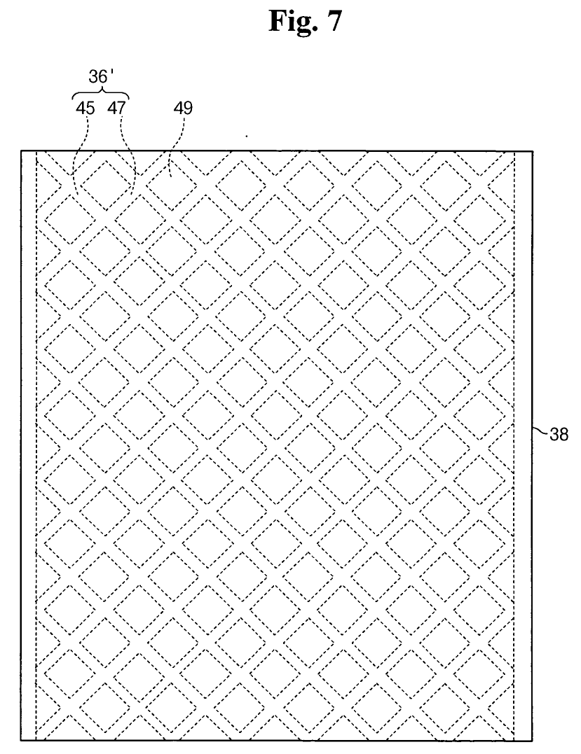

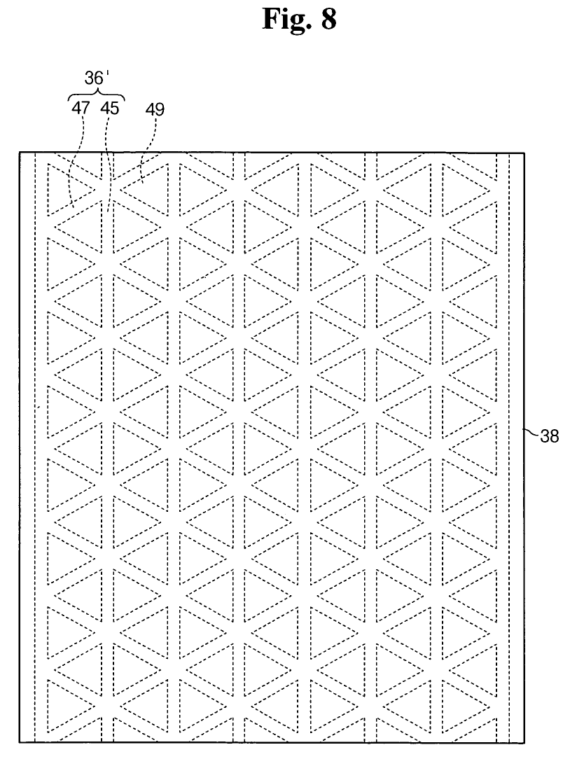

FIG. 7 is a first modified example and FIG. 8 is a second modified example of the second embodiment of the present invention. In the first and second modified examples of the second embodiment, pillars 49 defined by the main and branch channels 45, 47 may be rectangular or parallelogram-shaped (FIG. 7) or triangular (FIG. 8). The pillars of the present invention may also be circular or have a variety of other shapes.

The present invention is not limited to the exemplary embodiments and the modified examples that have been described. Rather, it includes various forms and modifications and that do not depart from the scope of the detailed description, the accompanying drawings, and the appended claims of the present invention.

What is claimed is:

1. A fuel cell stack having at least one electricity generator adapted to generate electric energy through an electrochemical reaction between hydrogen and oxygen and cooling channels adapted to contain a coolant for cooling the electricity generator, the cooling channels comprising:
a plurality of main channels; and
at least one branch channel branching from at least one of the main channels and coupling the main channels together.

2. The fuel cell stack of claim 1, wherein the main channels are located parallel to one another and the at least one branch channel is located perpendicular to the main channels.

3. The fuel cell stack of claim 1, wherein the electricity generator comprises:
a membrane-electrode assembly having two sides; and
separators located on both sides of the membrane-electrode assembly,
wherein the cooling channels are formed in the separators.

4. The fuel cell stack of claim 3, wherein intersections of the main channels and the branch channel define protrusions having a rectangular shape.

5. The fuel cell stack of claim 3, wherein intersections of the main channels and the branch channel define protrusions having a parallelogram shape.

6. The fuel cell stack of claim 3, wherein intersections of the main channels and the branch channel define protrusions having a triangular shape.

7. The fuel cell stack of claim 3, wherein the stack comprises a plurality of the electricity generators, wherein the separators between two adjacent membrane-electrode assemblies are placed opposite each other, and wherein the cooling channels are formed by combining the opposite separators.

8. The fuel cell stack of claim 7, wherein the membrane-electrode assembly is attached on one side of the combined opposite separators.

9. The fuel cell stack of claim 1, wherein the stack comprises a plurality of the electricity generators, wherein the stack further comprises cooling plates located between the electricity generators, and wherein the cooling channels are formed in cooling plates.

10. The fuel cell stack of claim 9, wherein intersections of the main channels and the branch channel define pillars having a rectangular shape.

11. The fuel cell stack of claim 9, wherein intersections of the main channels and the branch channel define pillars having a parallelogram shape.

12. The fuel cell stack of claim 9, wherein intersections of the main channels and the branch channel define pillars having a triangular shape.

13. A stack for a fuel cell system, the stack comprising:
a plurality of membrane-electrode assemblies;
a plurality of separators placed between adjacent membrane-electrode assemblies in separator pairs;
a plurality of main channels formed along a first direction between the separator pairs;
a plurality of branch channels formed between the separator pairs, the branch channels formed along a second direction intersecting the first direction and connecting the main channels together;
a plurality of inlets, each inlet formed in each separator pair and connected to the main channel formed between the separator pair; and
a plurality of outlets, each outlet formed in each separator pair and connected to the main channel formed between the separator pair,
wherein the main channels and the branch channels of each separator pair are adapted to receive a cooling fluid injected through the inlet and flowing out of the outlet.

14. The stack of claim 13, wherein intersection of the main channels and the branch channels forms a grid of channels with solid protrusions in between.

15. The stack of claim 14, wherein the protrusions are rectangular.

16. The stack of claim 14, wherein the protrusions are triangular.

17. The stack of claim 14, wherein the protrusions are parallelograms.

18. The stack of claim 14, wherein the protrusions are circular.

19. A stack for a fuel cell system, the stack comprising:
a plurality of unit cells, each unit cell having a membrane-electrode assembly located between two separators contacting the membrane-electrode assembly on both sides;
a plurality of cooling plates placed between adjacent unit cells;
a plurality of main channels formed along a first direction in the cooling plates;
a plurality of branch channels formed in the cooling plates, the branch channels formed along a second direction intersecting the first direction and connecting the main channels together;
a plurality of inlets, each inlet formed in one cooling plate and connected to the main channel formed in the cooling plate; and
a plurality of outlets, each outlet formed in each cooling plate and connected to the main channel formed in the cooling plate;
wherein the main channels and the branch channels of each cooling plate are adapted to receive a cooling fluid injected through the inlet and flowing out of the outlet.

20. The stack of claim 19, wherein intersection of the main channels and the branch channels forms a grid of channels with solid pillars in between, and wherein the pillars are shaped in a form selected from the group consisting of rectangular form, triangular form, parallelogram form, circular form, or a combination thereof.
